(19) United States
(12) Patent Application Publication
(10) Pub. No.: US 2014/0154357 A1
(43) Pub. Date: Jun. 5, 2014

(54) EMULSIFIER COMPOSITIONS AND METHODS OF USING SUCH EMULSIFIER COMPOSITIONS

(71) Applicants: Shireen S. Baseeth, Decatur, IL (US); Michael Price, Mt.Zion, IL (US); Bruce Sebree, Oakley, IL (US)

(72) Inventors: Shireen S. Baseeth, Decatur, IL (US); Michael Price, Mt.Zion, IL (US); Bruce Sebree, Oakley, IL (US)

(73) Assignee: ARCHER DANIELS MIDLAND COMPANY, Decatur, IL (US)

(21) Appl. No.: 14/125,396

(22) PCT Filed: Jun. 29, 2012
(86) PCT No.: PCT/US12/44810

§ 371 Date: Dec. 11, 2013

Related U.S. Application Data
(60) Provisional application No. 61/503,101, filed on Jun. 30, 2011.

(51) Int. Cl. A23L 1/035

(52) U.S. Cl. CPC A23L 1/035
USPC 426/62; 426/654; 426/631; 426/311

(57) ABSTRACT

Emulsifier compositions comprising an emulsifier and lecithin are disclosed. The emulsifier compositions may be in a dry form and may be used to disperse compounds in water.

### CROSS REFERENCE TO RELATED APPLICATIONS

This application claims priority to U.S. Provisional Patent Application No. 61/503,101, filed Jun. 30, 2011, the contents of the entirety which is incorporated by this reference.

### TECHNICAL FIELD

Various embodiments of the present disclosure relate to emulsifier compositions that can be used in food or industrial applications. Other embodiments relate to dry emulsifier blends that can be used to make various dry products more dispersible in water.

### BACKGROUND

Dry emulsifiers may be used to aid in hydrating dry products. For instance, in the manufacture of dry baker's yeast, emulsifiers are used to encapsulate the yeast from exposure to moisture and to aid in the rehydration of the yeast in dough.

One emulsifier that has been used in the dry yeast industry is sorbitan monostearate (SMS). SMS is a low HLB (hydrophilic-lipophilic balance) emulsifier (HLB of about 4.5) which has a high melting point and needs to be heated to around 65° C. in order to be emulsified in water. The process of combining SMS at temperatures over 60° C. with yeast results in a loss of some of the yeast due to thermal degradation.

Another emulsifier that has been used in the dry yeast industry is citric acid ester of monoglyercides (CITREM). CITREMs can be used as a complete or partial replacement of SMS. The CITREMs have a higher HLB than SMS, and are more hydrophilic and water dispersible than the SMS. Esters of saturated fatty acids of glycerol and/or fatty acid esters of propylene glycol may also be used as emulsifiers. However, these emulsifiers suffer from the drawback in that they are very expensive and have limited solubility in cold water.

Thus, a need exists for dry emulsifiers that are more functional and cost effective.

### SUMMARY OF THE INVENTION

In each of its various embodiments, the present invention fulfills these needs and discloses emulsifier compositions that are more cost effective and find utility in food and industrial applications.

In one embodiment, an emulsifier composition comprises an emulsifier and lecithin. The emulsifier composition is in a dry form. Uses of the emulsifier composition to disperse a dry compound are also disclosed.

In another embodiment, a method comprises mixing a dry emulsifier with a dry lecithin, thus producing an emulsifier blend.

In yet further embodiment, a composition comprises de-oiled lecithin and sorbitan monostearate or sucrose ester. The composition is in a dry form.

In an additional embodiment, a process for producing a yeast product comprises melting an emulsifier composition comprising lecithin and an emulsifier, suspending the emulsifier composition in water, mixing the suspended emulsifier composition with a dehydrated yeast, thus producing the yeast product, and drying the yeast product.

### DESCRIPTION OF THE DRAWINGS

FIG. 1 shows the dispersability of one embodiment of a composition of the present invention.

FIG. 2 shows the surface tensions of various embodiments of compositions of the present invention.

FIG. 3 shows the surface tensions of other embodiments of compositions of the present invention.

FIG. 4 shows the surface tensions of additional embodiments of compositions of the present invention.

FIG. 5 shows the electrolyte tolerance of embodiments of compositions of the present invention.

FIG. 6 shows a graphical representation of the wettability of a composition of one embodiment of the present invention.

### DETAILED DESCRIPTION OF THE INVENTION

In the present application, including the claims, other than in the operating examples or where otherwise indicated, all numbers expressing quantities or characteristics are to be understood as being modified in all instances by the term “about”. Unless indicated to the contrary, any numerical parameters set forth in the following description may vary depending on the desired properties in the compositions and methods of the present disclosure. At the very least, and not as an attempt to limit the application of the doctrine of equivalents to the scope of the claims, each numerical parameter described in the present description should be construed in light of the number of reported significant digits and by applying ordinary rounding techniques.

Any patent, publication, or other disclosure material, in whole or in part, that is incorporated by reference herein is incorporated only to the extent that the incorporated material does not conflict with existing definitions, statements, or other disclosure material set forth in this disclosure. The disclosure herein supersedes any conflicting material incorporated by reference.

The embodiments disclosed herein are directed to compositions and methods that comprise a composition comprising a lecithin and another emulsifier that forms a dry emulsifier blend. The dry emulsifier blend may be a powder and may have a moisture content of less than 5% by weight. In another embodiment, particles of the composition may have a mean particle size of between 5 and 2000 microns, and in another embodiment has a means particle size of between 10 and 300 microns.

In one embodiment, lecithin is mixed with a low HLB emulsifier and in another embodiment, the lecithin is mixed with a high HLB emulsifier. In various embodiments, the composition is a blend of lecithin in amounts ranging from 5 to 95% by weight, 10 to 90% by weight, from 20% to 80% by weight of the disclosed compositions, and in certain embodiments from 30% to 70% by weight; and the other emulsifier is present in amounts ranging from 5 to 95% by weight, 10 to 90% by weight, from 20% to 80% by weight of the disclosed compositions, and in certain embodiments from 30% to 70% by weight.

Lecithin is a lipid substance found in animal and plant tissues such as, for example, egg yolk, soybean, and canola or rapeseed. Lecithin includes constituents including, but not limited to, phospholipids, such as, for example, phosphatidyl choline (“PC”), phosphatidyl inositol (“PI”), and phosphatidyl ethanolamine (“PE”). The amphiphilic properties of lecithin make it an effective processing aid, emulsifier, dispersant, and/or surfactant. Lecithin is also a natural ingredient than can form nanodispersions in aqueous mediums and carry high loads of actives. But, in such aqueous mediums, lecithin tends to have limited tolerance to pH and electrolytes.

Lecithins suitable for use in the disclosed compositions and methods include, but are not limited to, crude filtered lecithin, fluid lecithin, de-oiled lecithin, chemically and/or enzymatically modified lecithin, standardized lecithin, and blends of any thereof Lecithins employed in the present disclosure generally tend to have a hydrophilic-lipophilic balance (“HLB”) value ranging from 1.0 to 10.0 depending on the processing conditions and additives used to obtain and produce the lecithin. For example, crude filtered lecithin has an HLB value of approximately 4.0 and favors the formation of water-in-oil emulsions. Standardized lecithin includes co-emulsifiers having HLB values ranging from 10.0 to 24.0, which results in lecithin compositions having HLB values of 7.0 to 12.0 and favoring oil-in-water emulsions. Any lecithin or combinations of lecithins are suitable for use in the disclosed compositions and methods regardless of the initial HLB value of the lecithin. Lecithins useful in the disclosed compositions and methods may comprise co-emulsifiers having a hydrophilic-lipophilic balance value ranging from 10.0 to 24.0, and in certain embodiments 10.0 to 18.0.

In another embodiment, the lecithin of the present invention is de-oiled lecithin. U.S. Pat. No. 6,140,519, incorporated by reference herein and assigned to Archer-Daniels-Midland Company, assignee of the present application, describes processes for producing de-oiled lecithins which may be used in the present application.

In another embodiment, ULTRALEC brand de-oiled lecithins available from Archer-Daniels-Midland Company of Decatur, Ill., may be used in the compositions and methods of the present invention. ULTRALEC brand de-oiled lecithins have a minimum of 97% acetone insolubles, maximum of 1% moisture, maximum of 0.05% hexane insolubles, and an effective HLB of 7.

The emulsifier and/or surfactant properties of an amphiphilic substance such as lecithin may be predicted by its hydrophilic-lipophilic balance (“HLB”) value. The HLB value may function as an index of the relative preference of an amphiphilic substance for oil or water—the higher the HLB value, the more hydrophilic the molecule; the lower the HLB value, the more hydrophobic the molecule. A description of HLB values is provided in U.S. Pat. No., 6,677,327. HLB is also described in Griffin, “Classification of Surface-Active Agents by ‘HLB,’” J. Soc. Cosmetic Chemists 1 (1949); Griffin, “Calculation of HLB Values of Non-Ionic Surfactants,” J. Soc. Cosmetic Chemists 5 (1954); Davies, “A quantitative kinetic theory of emulsion type, I. Physical chemistry of the emulsifying agent,” Gas/Liquid and Liquid/Liquid Interfaces, Proceedings of the 2d International Congress on Surface Activity (1957); and Schick, “Nonionic Surfactants: Physical Chemistry”, Marcel Dekker, Inc., New York, N.Y., pp. 439-47 (1987).

The embodiments disclosed herein are also directed to methods of preparing the disclosed compositions. In one embodiment, a dry form of a lecithin is mixed with a dry form of an emulsifier. In another embodiment, the dry lecithin and the dry emulsifier may be ground together to obtain a desired particle size, such as a mean particle size of between 10 and 300 microns.

In one embodiment, the emulsifier mixed with the lecithin is a low HLB emulsifier including, but not limited to, sorbitan monostearate, and in another embodiment, the emulsifier mixed with the lecithin is a high HLB emulsifier including, but not limited to, a sucrose ester. The high HLB emulsifier may have an HLB value of between 10-18 or between 14-18 and the low HLB emulsifier may have an HLB value of between 3-9 or between 3-6. In other embodiments, the emulsifier may be sorbitan monostearate, a sucrose ester, an alkylpolyglycoside, a sorbitan ester, a polyglycerol ester, a polyol ester, an isosorbide ester, an alkylpolyglucoside, or combinations of any thereof. In yet an additional embodiment, the emulsifier may be cationic, anionic, nonionic, or zwitterionic.

In another embodiment, the emulsifier mixed with the lecithin may be an alkylpolyglycoside (APG), which may have utility in a number of agricultural applications such as water dispersible pesticide dispersants. A wettable agricultural compound may be mixed with the emulsifier and/or lecithin described herein and milled to a fined particle size for addition to water, thus producing a dispersible agricultural product. The wettable agricultural compound may be a water dispersible granule. In one embodiment, the agricultural compound may be an agricultural sulfur product and used as a nutrient, soil amendment, or pesticide. In a further embodiment, the dispersible agricultural product may be used on a vine crop including, without limitation, grapes, tomatoes, or peanuts.

The embodiments disclosed herein are also directed to methods of using the disclosed compositions. In various embodiments, the disclosed compositions may be used in food systems to instantize food ingredients. The food ingredients may include: cocoa products including, but not limited to, cocoa powder; proteins including, but not limited to, wheat proteins, soy proteins, canola proteins, dairy proteins, sodium caseinates, milk proteins, egg proteins, and whey proteins; milk powder; nutraceuticals including, but not limited to, sterols and/or sterol esters; minerals; vitamins; high fat food ingredients; high protein food ingredients; and dehydrated yeast. The emulsifier composition may also be used in conjunction with vegetable oils to produce emulsions. The disclosed compositions may also be used in cosmetics and personal care products, or even agricultural products.

In another embodiment, the compositions of the present invention may be used in a process for producing a dehydrated yeast product. Such process may include providing a yeast having desired moisture and/or protein content. The yeast may be crumbled and/or mixed with an emulsifier composition of the present invention. The emulsifier may be prepared by melting the emulsifier composition and suspending the melted emulsifier composition in water with mixing, thus forming an emulsion. Since the emulsifier compositions of the present invention melt at a lower temperature than conventional emulsifiers such as sorbitan monostearate, it is expected that the yeast will be subjected to less thermal degradation and be more viable. This emulsion is added to yeast at an amount of up to 0.25% on a dry weight basis. The yeast/emulsion combination may be extruded through a screen to form particles of the yeast/emulsifier composition. This yeast/emulsifier composition may be dried, collected, and packed.

In a further embodiment, the emulsifier composition may be used in dry bakery mixes for producing cakes, muffins, cookies, bread, pie crust, biscuits, pancakes, or other bakery products. In such mixes, the emulsifier composition may help disperse food ingredients including, but not limited to, a cocoa product, a sterol, a vitamin, a mineral, milk powder, a fat containing product, a protein containing ingredient, a high fat milk powder, modified starch, and a dehydrated yeast.

### EXAMPLES

The following exemplary, non-limiting examples are provided to further describe the embodiments presented herein. Those having ordinary skill in the art will appreciate that variations of these Examples are possible within the scope of the invention.

### Example 1

Sorbitan monostearate (SMS) is a low HLB water/oil emulsifier that is not soluble/dispersible in cold water and needs to be melted at 60° C. to dissolve. However, SMS falls out of solution once it cools. Typically, SMS is used in combination with Polysorbate 60 or 80 to stabilize such emulsions.

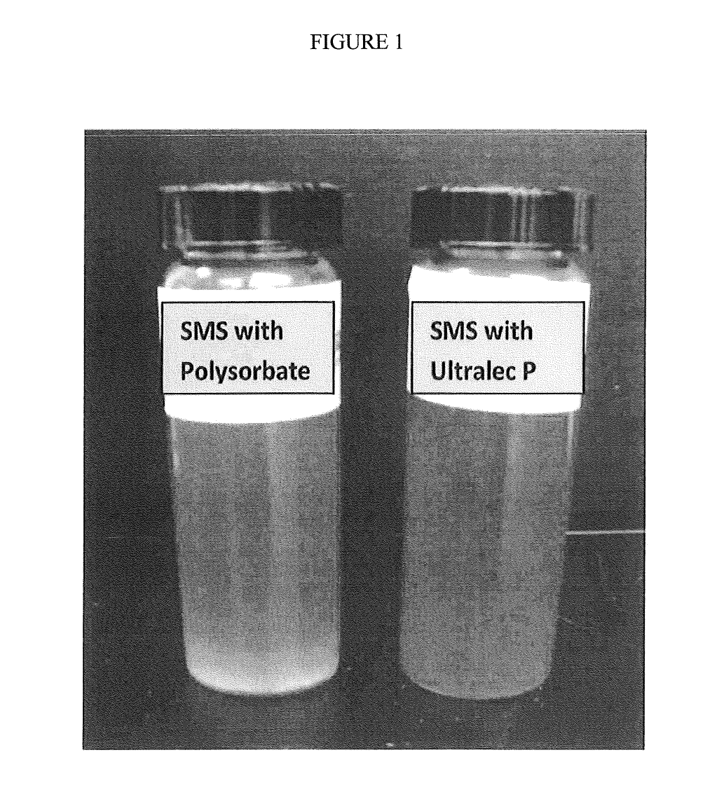

A small amount of Polysorbate 80 (high HLB) and orange red dye (to shown differences) were added to a hot SMS solution and the Polysorbate 80 completely dissolved in the hot SMS. The SMS has no effect in its dispersibility after the addition of the Polysorbate as shown by separation on the left side of FIG. 1 where there is settled material on the bottom of the tube.

An amount of ULTRALEC P brand de-oiled lecithin (available from Archer-Daniels-Midland Company of Decatur, Ill.) and orange red dye were added to hot solution of SMS and upon cooling, it was unexpectedly noticed that the de-oiled lecithin completely remained dispersible in the SMS with no separation as shown on the right side of FIG. 1.

### Example 2

Dry blends of de-oiled lecithin (ULTRALEC P brand de-oiled lecithin available from Archer-Daniels-Midland Company of Decatur, Ill.) and sorbitan monostearate (SMS (available from BASF, USA) were made by weighing out appropriate amounts of the de-oiled lecithin and the sorbitan monostearate to produce the following blends: 30:70 blend of de-oiled lecithin:SMS; 50:50 blend of de-oiled lecithin:SMS; and 70:30 blend of de-oiled lecithin:SMS. The weighed out emulsifiers were made into a fine powder in a lab scale grinder.

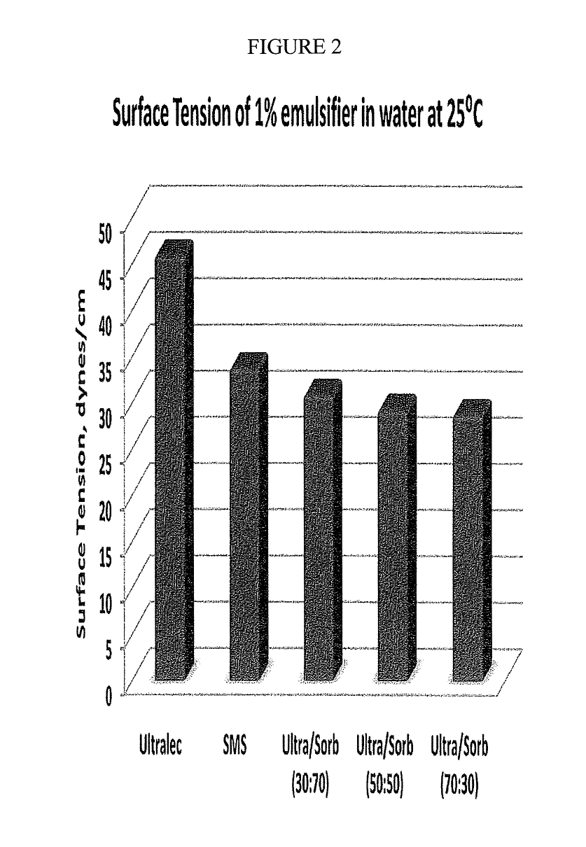

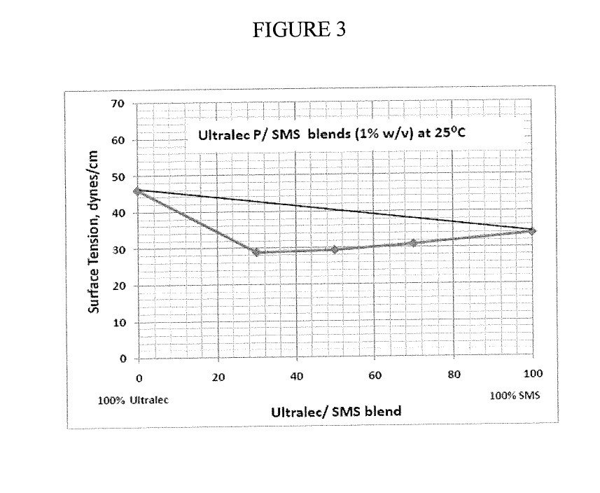

The surface tensions of de-oiled lecithin, SMS, and the three blends in a 1% solution in water were measured at 25° C. The de-oiled lecithin had a surface tension of 45 dynes/cm at 1% and the SMS at a similar concentration had a surface tension of about 28 dynes/cm. The surface tension of de-oiled lecithin, SMS, and the three blends of de-oiled lecithin:SMS at 30:70, 50:50, and 70:30 are shown in FIG. 2. The surface tensions of the three blends were all comparable to the surface tension of SMS alone, which shows a good synergism of such blends. FIG. 3 is a graph showing the synergism of the blends of this Example. It appears that irrespective of the blend ratio, the wetting properties of the emulsifier blends remain relatively unchanged as compared to the SMS alone, but has the added benefit that since de-oiled lecithin melts at a lower temperature than SMS, such blends would work well in the yeast industry or other applications where lower melting temperatures are desired.

### Example 3

Dry blends of de-oiled lecithin (ULTRALEC P brand de-oiled lecithin available from Archer-Daniels-Midland Company of Decatur, Ill.) and sucrose ester L-1695, a sucrose laurate (available from Mitsubishi-Kagaku Foods Corporation, USA) were made by weighing out appropriate amounts of the de-oiled lecithin and the sucrose ester to produce the following blends: 10:90 blend of sucrose ester:de-oiled lecithin; 30:70 blend of sucrose ester:de-oiled lecithin; 50:50 blend of sucrose ester:de-oiled lecithin; 70:30 blend of sucrose ester:de-oiled lecithin; and 90:10 blend of sucrose ester:de-oiled lecithin. The weighed out emulsifiers were made into a fine powder in a lab scale grinder.

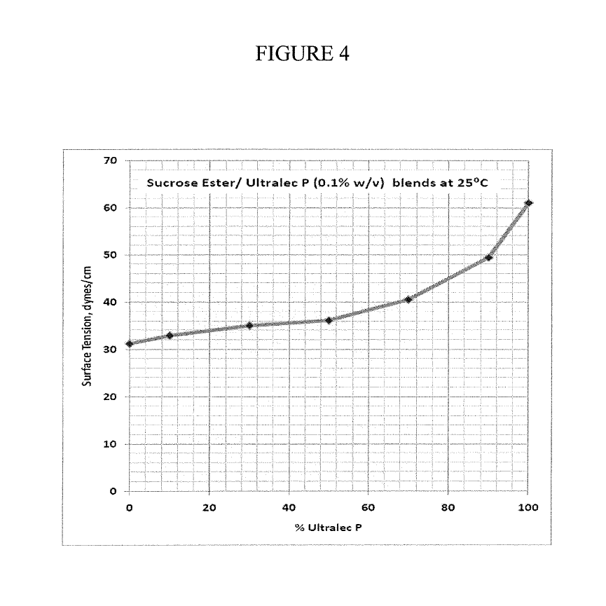

0.1% solutions of de-oiled lecithin, sucrose ester, and the five sucrose ester:de-oiled lecithin blends were prepared. The surface tension of each of the solutions was measured at 25° C. The surface tensions are shown in FIG. 4 with the far left point being 100% sucrose ester and the far right point being 100% de-oiled lecithin, with the varying amounts in between. The de-oiled lecithin added to the sucrose ester does not substantially alter the properties of the emulsifier combination as compared to the sucrose ester itself. The sucrose ester L-1695 (sucrose laurate with 80% monoester) has a HLB of about 16 and a surface tension of about 32 dynes/cm, but also has high foaming. Adding the de-oiled lecithin to the sucrose ester maintains the surface tension to be comparable to that of the sucrose ester alone, but also reduces the foaming. Also, since sucrose esters perform well at low pH and high electrolyte concentrations, it is expected that the de-oiled lecithin/sucrose ester combination would also work well under such pH and electrolyte concentrations.

### Example 4

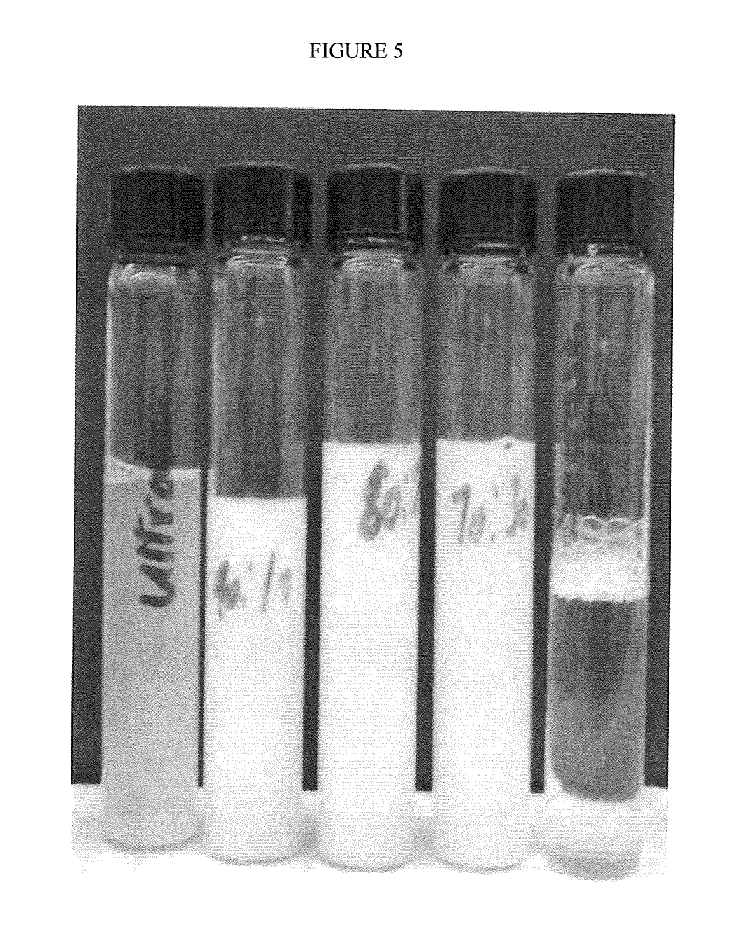

1% w/v solutions of ULTRALEC P brand de-oiled lecithin, sucrose ester, 90:10 blend of de-oiled lecithin:sucrose ester; 80:20 blend of de-oiled lecithin:sucrose ester; 70:30 blend of de-oiled lecithin:sucrose ester were prepared in the presence of 1% sodium chloride. FIG. 5 shows that the de-oiled lecithin by itself did not show electrolyte tolerance as evidenced by the settling of material at the bottom of the tube, but the blends of the de-oiled lecithin:sucrose ester did show electrolyte tolerance as evidenced by the uniform color and lack of material settled at the bottom of the tubes. From left to right in FIG. 5: de-oiled lecithin; 90:10 blend of de-oiled lecithin:sucrose ester; 80:20 blend of de-oiled lecithin:sucrose ester; 70:30 blend of de-oiled lecithin:sucrose ester; and sucrose ester.

### Example 5

SMARTBIND brand wheat protein isolate (available from ADM Milling Company of Overland Park, Kans.) was agglomerated with water and an emulsifier solution comprising de-oiled lecithin/sucrose ester or lecithin/polyglycerol ester. The de-oiled lecithin was ULTRALEC P brand de-oiled lecithin (available from Archer-Daniels-Midland Company of Decatur, Ill.). The lecithin was YELKIN SS brand lecithin (available from Archer-Daniels-Midland Company of Decatur, Ill.) and the polyglycerol ester was POLYALDO 10-1-CC KFG brand polyglycerol ester (available from Lonza Group Ltd. of Basel, Switzerland).

The wheat protein isolate was spray agglomerated with 30° C. water, followed by spray agglomeration with the emulsifier solution (5% solids) at 40° C. in the amounts shown in Table 1.

TABLE 1

| | | Total | De-oiled | Sucrose | Batch | | Water | Emulsifier | | Emulsifier |
|---|---|---|---|---|---|---|---|---|---|---|
| | SmartBind | emulsifier | lecithin | Esters | Weight | Emulsifier | Applied | dry solids | Water | solution |
| Run | (grams) | (grams) | (%) | (%) | (grams) | (%) | (30°) | (grams) | (grams) | (grams) |
| 1 | 985.0 | 15.0 | 100.0 | 0.0 | 1000.0 | 1.50 | 150.0 | 15.0 | 285.0 | 300.0 |
| 2 | 992.5 | 7.5 | 70.0 | 30.0 | 1000.0 | 0.75 | 300.0 | 7.5 | 142.5 | 150.0 |
| 3 | 980.0 | 20.0 | 100.0 | 0.0 | 1000.0 | 2.00 | 50.0 | 20.0 | 380.0 | 400.0 |
| 4 | 992.5 | 7.5 | 50.0 | 50.0 | 1000.0 | 0.75 | 300.0 | 7.5 | 142.5 | 150.0 |
| 5 | 992.5 | 7.5 | 90.0 | 10.0 | 1000.0 | 075 | 300.0 | 7.5 | 142.5 | 150.0 |
| 6 | 992.5 | 7.5 | 90.0 | 10.0 | 1000.0 | 0.75 | 300.0 | 7.5 | 142.5 | 150.0 |
| | | | (lecithin, | (polyglycerol | | | | | | |
| | | | not de- | ester, not | | | | | | |
| | | | oiled) | sucrose) | | | | | | |

After agglomeration, 12.5 grams of the agglomerated products were dispersed into 237.5 grams of water at ambient temperature. The results of the dispersion are shown in Table 2, where the blends of de-oiled lecithin and sucrose esters were more dispersible than the de-oiled lecithin or sucrose esters individually.

TABLE 2

| Rank in | | |
|---|---|---|
| Dispersibility | Run | Comments |
| 1 | 2 | More hygroscopic powder |
| 1 | 6 | |
| 2 | 5 | Some ringing of material on beaker |
| 3 | 4 | More hydroscopic powder, ringing of material |
| | | on beaker |
| 4 | 3 | |
| 5 | 1 | |

### Example 6

A dry blend of 80% de-oiled lecithin (ULTRALEC P brand de-oiled lecithin available from Archer-Daniels-Midland Company of Decatur, Ill.) and 20% sucrose ester L-1695, a sucrose laurate (available from Mitsubishi-Kagaku Foods Corporation, USA) was made.

A particle size analysis of the sucrose esters was performed which showed the sucrose esters to be a large waxy and flaky type particle having a bulk density of 0.40 g/cc, where greater than 80% of a particle size distribution of the sucrose esters were greater than 40 mesh (400 μm). In an initial blending trial of the sucrose esters with the de-oiled lecithin, the blend was not uniform and possibly subject to segregation.

Milling trials of the sucrose esters using a Fitzmill L1-A to mill the sucrose esters were performed to determine the parameters needed to reduce the particle size of the sucrose esters to a size substantially the same as the de-oiled lecithin particles, i.e., such that greater than 80% of the sucrose ester particles had a size smaller than 40 mesh (400 μm). Blending trials were performed on the milled sucrose esters and the de-oiled lecithin using a batch v-shell blender and it was found that a two minute batch blend resulted in a visibly uniform blend of the de-oiled lecithin particles and the milled sucrose esters. After such successful blending trial, the blending was scaled up using: a low range MECHATRON LIW brand vibro feeder from Schench AccuRate to feed the de-oiled lecithin at a rate of 14 lb/hr (6.35 kg/hr); a Schenck 302 screw feeder was used to feed the sucrose esters at a rate of 6 lb/hr (2.72 kg/hr); and a zig-zag blender with a shell rpm set at 10 and a theoretical residence time of 5 minutes was used to blend the sucrose esters and de-oiled lecithin. Such blending trials resulted in a composition having uniformly blended 20% sucrose esters and 80% de-oiled lecithin having substantially the same particle size.

### Example 7

High fat milk powder was agglomerated with the de-oiled lecithin/sucrose ester blend of Example 6. The high fat milk powder (fat content of between 25-30%, available from Land-O-Lakes) was spray agglomerated with 30° C. water, followed by spray agglomeration with the de-oiled lecithin/sucrose ester blend in solution at 5% solids at 40° C. using a Stephan Mixer. The solution was sprayed at a slow rate and constant stirring under vacuum. The agglomerated milk powder was allowed to dry to a moisture level of less than 1%. High fat milk powder was also agglomerated without the de-oiled lecithin/sucrose ester blend as a control.

### Example 8

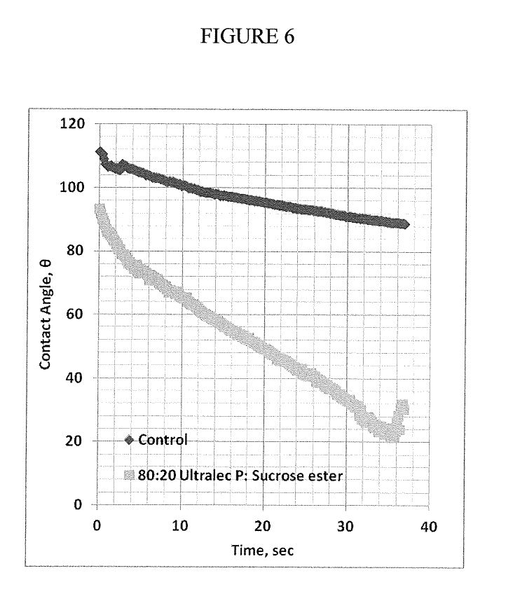

Contact angle measurements were performed on the agglomerated milk powder including the de-oiled lecithin/sucrose ester blend and the control prepared in Example 7 in order to determine the rate of wetting/dispersibility. Measurements were done using a Kruss Easy Drop Angle, Model V-103, instrument. The agglomerated milk powder samples were packed in a rectangular well plate and a water drop was placed on the milk powder bed. A video of each sample was taken using the Kruss Easy Drop Angle instrument and the contact angle versus time was measured. To determine the rate of wetting, the contact angle was plotted versus time. The slope is indicative of the time taken for the sample to disperse in water and allows for the quantification of the wettability of solid powders. The results are presented in Table 3 and FIG. 6. The average was determined on more than ten measurements. The higher the slope, the faster the wetting rate of the powder.

TABLE 3

| | | | Average | Average | Average |
|---|---|---|---|---|---|
| | Average | Average | Contact Angle, | Contact Angle, | Contact Angle, |
| Sample | Slope, t₀ | Correlation | Time 0 seconds | Time 13.5 seconds | Time 40 seconds |
| Control (milk powder) | 0.470 | 0.964 | 105.86 | 98.30 | 88.00 |
| Milk powder and de-oiled | 1.722 | 0.990 | 83.76 | 59.00 | 43.30 |
| lecithin/sucrose ester blend | | | | | |

This disclosure has been described with reference to certain exemplary embodiments, compositions and uses thereof. However, it will be recognized by those of ordinary skill in the art that various substitutions, modifications or combinations of any of the exemplary embodiments may be made without departing from the spirit and scope of the disclosure. Thus, the disclosure is not limited by the description of the exemplary embodiments, but rather by the claims as originally filed.

1. An emulsifier composition, comprising:
an emulsifier; and
lecithin;
the emulsifier composition being in a dry form.

2. The emulsifier composition of claim 1, wherein the lecithin is selected from the group consisting of crude filtered lecithin, fluid lecithin, de-oiled lecithin, chemically and/or enzymatically modified lecithin, standardized lecithin, and combinations of any thereof.

3. The emulsifier composition of claim 1, wherein the lecithin is de-oiled lecithin.

4. The emulsifier composition of claim 1, wherein the emulsifier has an HLB value of between 3-9.

5. The emulsifier composition of claim 1, wherein the emulsifier has an HLB value of between 10-18.

6. The emulsifier composition of claim 1, wherein the emulsifier is cationic, anionic, nonionic, or zwitterionic.

7. The emulsifier composition of claim 1, wherein the emulsifier is selected from the group consisting, of sorbitan monostearate, a sucrose ester, an alkylpolyglycoside, a sorbitan ester, a polyglycerol ester, a polyol ester, an isosorbide ester, an alkylpolyglycoside, and combinations of any thereof.

8-9. (canceled)

10. The emulsifier composition of claim 1, wherein the emulsifier composition is a powder.

11. (canceled)

12. The emulsifier composition of claim 1, wherein upon dispersion of the emulsifier composition in an aqueous solution, the dispersed emulsifier composition is tolerant at extreme pH, extreme electrolyte, concentrations, and combinations thereof.

13-24. (canceled)

25. A method of dispersing a dry compound comprising:
mixing the dry compound with a dry emulsifier composition comprising an emulsifier and lecithin, thus producing a dry blend; and
placing the dry blend in an aqueous solution.

26. The method according to claim 25, wherein the dry compound is a protein.

27. The method according to claim 26, wherein the protein is selected from the group consisting of a wheat protein, a soy protein, a canola protein, a dairy protein, sodium caseinate, a whey protein, milk protein, an egg protein, and combinations of any thereof.

28. The method according to claim 25, wherein the dry compound is a cocoa product.

29. The method according to claim 25, wherein the dry compound is a dehydrated yeast or a modified starch.

30. The method according to claim 25, wherein the dry compound is a food ingredient.

31. The method according to claim 30, wherein the food ingredient is selected from the group consisting of a cocoa product, a sterol, a vitamin, a mineral, milk powder, a fat containing product, a protein containing ingredient, and a dehydrated yeast.

32. The emulsifier composition of claim 1, wherein the lecithin is de-oiled lecithin and the emulsifier is selected from the group consisting of sorbitan monostearate, sucrose ester, or a combination thereof.

33. A process fin producing a yeast product, comprising:
melting an emulsifier composition comprising lecithin and an emulsifier;
suspending the emulsifier composition in water;
mixing the suspending emulsifier composition with a dehydrated yeast, thus producing the yeast product; and
drying the yeast product,

34. The process of claim 33, wherein the lecithin is de-oiled lecithin.

35. The process of claim 33, wherein the emulsifier is selected from the group consisting of sorbitan monostearate, a sucrose ester, an alklpolyglycoside, a sorbitan ester, a polyglycerol ester, a polyol ester, an isosorbide ester, an alklpolyglycoside, and combinations of any thereof.

36. (canceled)
